(19) United States
(12) Patent Application Publication
(10) Pub. No.: US 2026/0289692 A1
(43) Pub. Date: Sep. 24, 2026

(54) CROWDSOURCED DETERMINATION OF QUEUING TIMES OF CHARGING STATIONS FOR ELECTRIC VEHICLES

(71) Applicant: HERE GLOBAL B.V., EINDHOVEN (NL)

(72) Inventors: LAURI AARNE JOHANNES WIROLA, TAMPERE (FI); HENRI NURMINEN, TAMPERE (FI); MARKO LUOMI, TAMPERE (FI)

(73) Assignee: HERE GLOBAL B.V., EINDHOVEN (NL)

(21) Appl. No.: 19/087,594

(22) Filed: Mar. 24, 2025

(51) Int. Cl. G06Q 50/06; B60L 53/60; B60W 60/00; G06Q 30/0601

(52) U.S. Cl. CPC G06Q 50/06; G06Q 30/0631; B60L 53/60; B60W 60/00

(57) ABSTRACT

A system, method, apparatus, etc., for crowdsourced determination of queuing times of charging stations for electric vehicles (EVs), wherein the queuing and charging statistics may be determined based on queuing times of EVs at charging stations. Location data of an EV and a charging station may be received by the apparatus. Based on these location data, charging station metadata, and other data, the queuing times may be determined. The queuing and times may be used to generate and transmit recommendation data for EVs.

### TECHNOLOGICAL FIELD

An example embodiment relates generally to a method, apparatus, computer readable storage medium, user interface and/or computer program product for charging an electric vehicle (EV) at one or more charging points, and more particularly, crowdsourced determination of queuing times of charging stations for EVs.

### BACKGROUND

The proliferation of EVs has resulted in an increase in the demand for EV charging infrastructure. The EV charging infrastructure must be built from the ground up, which requires resources and data. Further, the charging of EVs may be complex, time-consuming, and may depend on various factors, such as, connector types, charging speeds, vehicle characteristics/types, and other external factors.

Typically, EV drivers may encounter long charging durations and extended waiting periods if charging stations are unavailable or limited in number. Drivers may struggle to arrange their activities due to unpredictable charge or waiting durations. In such a case, the EV drivers may need to make educated guesses regarding charging outlet availability and charging times, which may degrade the charging experience of the EV drivers and cause anxiety.

### BRIEF SUMMARY

A method, apparatus, computer readable storage medium, user interface, and computer program product are provided in accordance with an example embodiment to determine queuing time of charging stations for electric vehicles.

In this regard, the method, apparatus, computer readable storage medium, and computer program product of an example embodiment may be an apparatus, the apparatus comprising at least one processor and at least one memory storing computer program code, the at least one memory and the computer program code configured to, with the processor, cause the apparatus to at least: receive charging station information including charging station location data and the charging station metadata of a charging station; receive first location data of an electric vehicle (EV) based on a distance of the EV from the charging station being within a threshold proximate distance. Further, the apparatus may receive second location data of the EV based on a determination that the EV is utilizing a charging point of the charging station; and determine a queuing time for the charging station, based at least in part on the first location data, the second location data, and the charging station metadata. In some embodiment, the charging station location data, the first location data, or the second location data is determined based on at least one of Global Positioning System (GPS) data associated with the EV, Global Navigation Satellite System (GNSS) data associated with the EV, or vehicle sensor data associated with the EV.

In yet other embodiments, the first location data or the second location data at least includes a current geographical location of the EV, and a current timestamp at the current geographical location.

In yet other embodiments, the charging station metadata includes at least one of a number of operational charging points at the charging station, a charger power output associated with each of the operational charging points, an availability of a fast-charging point among the charging points, or a charging time required for one or more EV models.

In yet other embodiments, the apparatus receives location data of another EV (also referred to as a second EV); generates recommendation data indicating the charging station as a recommended charging station for charging of the second EV, based at least on the location data of the second EV, the charging station location data, and the queuing time for the charging station; and transmits the recommendation data to an electronic device associated with the second EV.

In yet other embodiments, the apparatus generates recommendation data indicating a recommended charging capacity at the charging station, based at least on the charging station information and the queuing time for the charging station; and transmits the recommendation data to an electronic device associated with a charging infrastructure provider.

In yet other embodiments, the apparatus generates recommendation data indicating the charging station as a recommended charging station, based at least on the charging station information and the queuing time for the charging station; and transmits the recommendation data to an electronic device associated with a charging station search-provider or a charging station routing-provider.

In yet other embodiments, the apparatus determines queuing statistics for a plurality of charging stations including the charging station, based on the queuing time for the charging station and queuing times for other charging stations of the plurality of charging stations. The queuing statistics includes at least one of location-specific queuing times associated with the plurality of charging stations, charger-specific queuing times associated with the plurality of charging stations, charging capacity-specific queuing times associated with the plurality of charging stations, time-of-day-specific queuing times associated with the plurality of charging stations, or month-specific queuing times associated with the plurality of charging stations.

In yet other embodiments, the apparatus receives climate data associated the charging station location data, wherein the determination of the queuing time is further based on the climate data.

In yet other embodiments, the apparatus generates an automated vehicle control signal based at least in part on the queuing time of the charging station.

All this information/feedback may be displayed on an end user device (e.g., smartphone, tablet, etc.) and/or in a motor vehicle (e.g., upon a built-in vehicle display).

In other embodiments, a UI may be provided which displays in real-time the queuing time, queuing statistics, charging times, charging statistics, and multiple recommendation data that includes charging station as a recommended charging station, a route as a recommended route to the recommended charging stations, and the queuing time or charging time associated with the recommended charging stations. Further, users may also manually select a charging station from the recommended charging stations and a route from/to the selected charging station. The users may also filter the recommended charging stations based on queuing time/charging time associated with the respective charging stations.

Also, a computer program product may be provided. For example, a computer program product comprising instructions which, when the program is executed by a computer, cause the computer to carry out the steps described herein.

In yet another aspect, disclosed is an apparatus and/or non-transitory computer readable medium having stored thereon instructions executable by processor(s) to cause an apparatus to perform operations described herein, such as any of those set forth in the disclosed method(s), among others.

In yet another aspect, disclosed is a computer program product including instructions which, when the program is executed by a computer, cause the computer to carry out the steps described herein, such as any of those set forth in the disclosed method(s). In other words, the computer program product may have computer-executable program code portions stored therein, the computer-executable program code portions including program code instructions configured to perform any operations set forth in any of the method(s) disclosed herein, among others.

These as well as other features and advantages of the invention will become apparent from the following detailed description considered in conjunction with the accompanying drawings where appropriate. It should be understood, however, that the drawings are designed solely for the purposes of illustration and not as a definition of the limits of the present disclosure. It should be further understood that the drawings are not drawn to scale and that they are merely intended to conceptually illustrate one or more of the features described herein. None of the examples shown or discussed herein are limiting on any aspect of the claimed subject matter.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment;

FIG. 2 is a block diagram of a database of an example embodiment of the apparatus;

FIG. 3A is a flowchart illustrating the operations performed, such as, by the apparatus of FIG. 1, in order to determine queuing time and charging time based on received charging station information and locations associated with an EV;

FIG. 3B is a flowchart illustrating the operations performed, such as, by the apparatus of FIG. 1, in order to provide recommendation data for an electronic device associated with an EV, for a charging infrastructure provider, and for a charging station search-provider or a charging station routing-provider;

FIG. 4A is a graphical representation of a location of a charging station and a location of an EV approaching the charging station;

FIG. 4B is a graphical representation of a charging lot of a charging station within which the apparatus may be in use.

FIG. 5 is a graphical representation of a scenario with a recommendation provided to an EV and to a charging infrastructure provider; and

FIG. 6 is a graphical representation of a scenario with a recommendation provided to a charging station search-provider or a charging station routing-provider.

### DETAILED DESCRIPTION

Some embodiments of the present invention will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A system, method, apparatus, user interface, and computer program product are provided as example embodiments to determine crowdsourced queuing times of charging stations for electric vehicles (EVs). In order to provide such a service, the system, the method, the apparatus, a non-transitory computer-readable storage medium, and the computer program product of an example embodiment may be configured to receive charging station information including charging station location data and charging station metadata of a charging station; receive first location data of an EV based on a distance of the EV from the charging station being within a threshold proximate distance. The service, the system, the method, the apparatus, a non-transitory computer-readable storage medium, and the computer program product may be further configured to receive second location data of the EV based on a determination that the EV is utilizing a charging point of the charging station; and determine a queuing time for the charging station, based at least in part on the first location data, the second location data, and the charging station metadata. In some embodiments, the charging station location data, the first location data, or the second location data is determined based on at least one of Global Positioning System (GPS) data associated with the EV, Global Navigation Satellite System (GNSS) data associated with the EV, or vehicle sensor data associated with the EV.

The system, apparatus, method, etc. described above may be any of a wide variety of computing devices and may be embodied by either the same or different computing devices. The system, apparatus, etc. may be embodied by a server, a computer workstation, a distributed network of computing devices, a personal computer or any other type of computing device. The system, apparatus, etc. configured to determine crowdsourced queuing times of charging stations for EVs may similarly be embodied by the same or different server, computer workstation, distributed network of computing devices, personal computer, or other type of computing device.

Alternatively, the system, etc. may be embodied by a computing device on board a vehicle, such as a computer system of a vehicle, e.g., a computing device of a vehicle that supports safety-critical systems such as the powertrain (engine, transmission, electric drive motors, etc.), steering (e.g., steering assist or steer-by-wire), and/or braking (e.g., brake assist or brake-by-wire), a navigation system of a vehicle, a control system of a vehicle including but not limited to various automated vehicle controls, an electronic control unit of a vehicle, an autonomous vehicle control system (e.g., a semi or fully autonomous-driving control system) of a vehicle, a mapping system of a vehicle, an Advanced Driver Assistance System (ADAS) of a vehicle), or any other type of computing device carried by the vehicle. Still further, the apparatus may be embodied by a computing device of a driver or passenger on board the vehicle, such as a mobile terminal, e.g., a personal digital assistant (PDA), mobile telephone, smart phone, personal navigation device, smart watch, tablet computer, or any combination of the aforementioned and other types of portable computer devices.

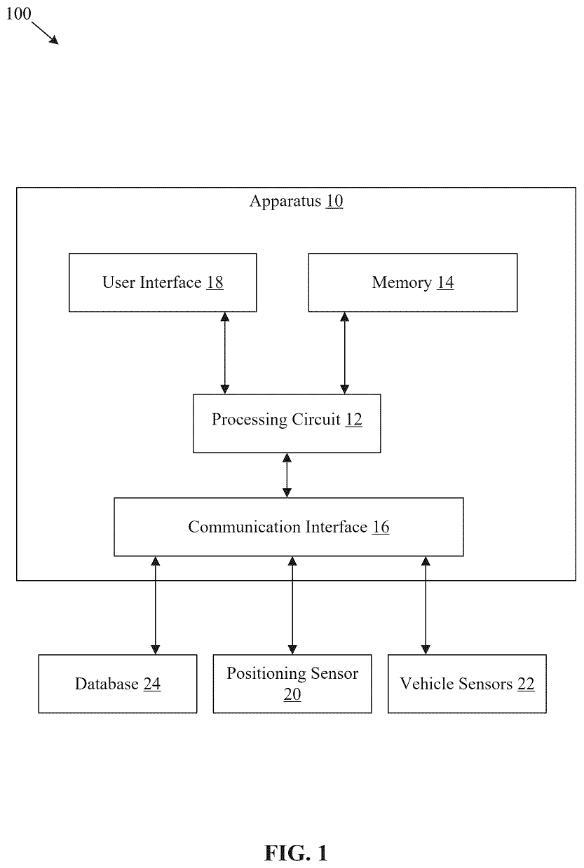

Regardless of the manner in which the system, apparatus, etc. is embodied, however, an apparatus 10 includes, is associated with, or is in communication with processing circuit 12, memory 14, a communication interface 16 and optionally a user interface 18 as shown in FIG. 1. In some embodiments, the processing circuit 12 (and/or co-processors or any other processors assisting or otherwise associated with the processing circuitry) can be in communication with the memory 14 via a bus for passing information among components of the apparatus. The memory 14 can be non-transitory and can include, for example, one or more volatile and/or non-volatile memories. In other words, for example, the memory 14 may be an electronic storage device (for example, a computer readable storage medium) comprising gates configured to store data (for example, bits) that can be retrievable by a machine (for example, a computing device like the processing circuitry). The memory 14 can be configured to store information, data, content, applications, instructions, or the like for enabling the apparatus to carry out various functions in accordance with an example embodiment of the present disclosure. For example, the memory 14 can be configured to buffer input data for processing by the processing circuit 12. Additionally, or alternatively, the memory 14 can be configured to store instructions for execution by the processing circuit 12.

The apparatus 10 may be specifically configured in accordance with an example embodiment of the present invention for crowdsourced determination of queuing times of charging stations for EVs. The apparatus 10 may include or otherwise be in communication with the processing circuit 12, the memory 14, the communication interface 16 and optionally the user interface 18. Further, the communication interface 16 may interact with a positioning sensor 20, vehicle sensors 22, and a database 24. The apparatus 10 may be configured to receive charging station information that may include charging station location data of a charging station, charging station metadata of a charging station, and location data associated with an EV to determine a queuing time for the charging station. As used herein, the term “queuing time” may also be known as waiting time, that refers to an amount of time an entity spends waiting in a queue before receiving service. In context of the present disclosure, the term “queuing time” may be the amount of time that an EV (e.g., a car, a truck, a motorbike, etc.) spends waiting in a queue for utilizing a charging point of a certain charging station.

The processing circuit 12 may be embodied in a number of different ways. For example, the processing circuit 12 may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuit 12 can include one or more processing cores configured to perform independently. A multi-core processor can enable multiprocessing within a single physical package. Additionally, or alternatively, the processing circuit 12 can include one or more processors configured in tandem via the bus to enable independent execution of instructions, pipelining and/or multithreading.

In an example embodiment, the processing circuit 12 may be configured to execute instructions stored in the memory 14 or otherwise accessible to the processing circuit 12. Alternatively, or additionally, the processing circuitry 12 may be configured to execute hard coded functionality. As such, whether configured by hardware or software methods, or by a combination thereof, the processing circuit 12 may represent an entity (for example, physically embodied in circuitry) capable of performing operations according to an embodiment of the present disclosure while configured accordingly. Thus, for example, when the processing circuit 12 may be embodied as an ASIC, FPGA or the like, the processing circuit 12 may be specifically configured hardware for conducting the operations described herein. Alternatively, as another example, when the processing circuit 12 may be embodied as an executor of software instructions, the instructions can specifically configure the processing circuit 12 to perform the algorithms and/or operations described herein when the instructions are executed. However, in some cases, the processing circuit 12 may be a processor of a specific device (for example, a computing device) configured to employ an embodiment of the present disclosure by further configuration of the processor by instructions for performing the algorithms and/or operations described herein. The processing circuit 12 can include, among other things, a clock, an arithmetic logic unit (ALU) and/or one or more logic gates configured to support operations of the processing circuit 12.

The apparatus 10 of an example embodiment may also include the memory 14 that may include suitable logic, circuitry, and/or interfaces that may be configured to store program instructions executable by the processing circuit 12. In certain embodiments, the memory 14 may be configured to store queuing information, charging information, location data, recommendation data, and metadata associated with charging stations. The memory 14 may include computer-readable storage media for carrying or having computer-executable instructions or data structures stored thereon. Such computer-readable storage media may include any available media that may be accessed by a general-purpose or special-purpose computer, such as the processing circuit 12.

By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processing circuit 12 to perform a certain operation or group of operations associated with the apparatus 10.

The apparatus 10 of an example embodiment may also include the communication interface 16 that may be any means such as a device or circuitry embodied in either hardware or a combination of hardware and software that is configured to receive and/or transmit data from/to other electronic devices in communication with the apparatus, such as, a database which, in one embodiment, comprises the database 24 that may store data (e.g., location data, queuing statistics, charging statistics, recommendation data, charging station information, etc.) generated and/or employed by the processing circuit 12. In an example, the database 24 may also store map data, such as, one or more map objects, point-of-interest (POI) data, etc. Additionally, or alternatively, the communication interface 16 may be configured to communicate in accordance with various wireless protocols including satellite communication systems (such as, through a network of low-earth orbit satellites), Global System for Mobile Communications (GSM), such as, but not limited to Long Term Evolution (LTE), 3G, 4G, 5G, 6G, etc. In this regard, the communication interface 16 may include, for example, an antenna (or multiple antennas) and supporting hardware and/or software for enabling communications with a wireless communication network. In this regard, the communication interface 16 may include, for example, an antenna (or multiple antennas) and supporting hardware and/or software for enabling communications with a wireless communication network. Additionally, or alternatively, the communication interface 16 may include the circuitry for interacting with the antenna(s) to cause transmission of signals via the antenna(s) or to handle receipt of signals received via the antenna(s). In some environments, the communication interface 16 may alternatively or also support wired communication and/or may alternatively support vehicle to vehicle or vehicle to infrastructure wireless links. The communication mediums may also be used to aid in position of a given end user, vehicle, and/or mobile device.

The apparatus 10 may also optionally include the user interface 18 that may, in turn, be in communication with the processing circuit 12 to provide output to the user and, in some embodiments, to receive an indication of a user input. As such, the user interface 18 may include a display and, in some embodiments, may also include a keyboard, a mouse, a joystick, a touch screen, touch areas, soft keys, one or more microphones, a plurality of speakers, or other input/output mechanisms. In one embodiment, the processing circuit 12 may comprise user interface circuitry configured to control at least some functions of one or more user interface elements such as a display and, in some embodiments, a plurality of speakers, a ringer, one or more microphones and/or the like. The processing circuit 12 and/or the user interface circuitry (such as, the user interface 18) embodied by the processing circuit 12 may be configured to control one or more functions of one or more user interface elements through computer program instructions (for example, software and/or firmware) stored on a memory accessible to the processing circuitry (for example, memory 14, and/or the like).

The user interface 18 may include suitable logic, circuitry, and interfaces that may be configured to render a User Interface (UI) with option(s) to configure and submit a dataset (i.e., charging station information, location data, or recommendation data) that may be associated with a charging station and an EV. The user interface 18 may further display a queuing time and/or a charging time determined for a charging station by the apparatus 10. The user interface 18 may communicate with the apparatus 10 via a network interface. Examples of the user interface 18 may include, but are not limited to, a mobile device, a desktop computer, a laptop, a virtual machine, a computer workstation, or a server, such as a cloud server. Further, the user interface 18 may include a display device. Furthermore, the display device may include suitable logic, circuitry, and interfaces that may be configured to accept inputs associated with the user and render outputs generated by the apparatus 10. The display device of the user interface 18 may be a touch screen which may enable a user to provide user-inputs via the display device. The touch screen may be at least one of a resistive touch screen, a capacitive touch screen, or a thermal touch screen. The display device may be realized through several known technologies such as, but not limited to, a Liquid Crystal Display (LCD) display, a Light Emitting Diode (LED) display, a plasma display, or an Organic LED (OLED) display technology, or other display devices. In accordance with an embodiment, the display device may refer to a display screen of a head mounted device (HMD), a smart-glass device, a see-through display, a projection-based display, an electro-chromic display, or a transparent display.

In certain embodiments, the apparatus 10 can be equipped or associated with one or more positioning sensors (for example, the positioning sensor 20), such as, one or more GPS or GNSS sensors, one or more accelerometer sensors, one or more light detection and ranging (LiDAR) sensors, one or more radar sensors, one or more gyroscope sensors, and/or one or more other sensors. Any of the one or more sensors may be used to sense information regarding movement, positioning and location, and/or orientation of the apparatus 10 for use, such as, by the processing circuit 12, in navigation assistance and/or autonomous vehicle control, as described herein according to example embodiments.

In certain embodiments, the apparatus 10 may further be equipped with or in communication with one or more vehicle sensors (such as, the vehicle sensors 22). In some example embodiments, the vehicle sensors 22 can be implemented in a vehicle or other remote apparatuses. The vehicle sensors 22 may include systems which capture image data (via one or more cameras, etc.), audio data (via one or more microphones, etc.), video data (via one or more video recorders, etc.), infrared (IR) data (via an IR sensor), temperature data (via a temperature sensor), and/or speed data (via a speedometer of the EV or a speed camera installed on a road segment).

For example, the vehicle sensors 22 may be in-built in a vehicle or proximate to it (e.g., traffic cameras, security cameras, etc.). While embodiments may be implemented with a single camera such as a front facing camera in a consumer vehicle, other embodiments may include the use of multiple individual cameras at the same time. A helpful example is that of a consumer sedan driving down a road. Many modern cars have one or more cameras installed on them to enable automatic braking and other types of assisted or automated driving. Many cars also have rear facing cameras to assist with automated or manual parking. In one embodiment of the current system, apparatus 10, method, etc. the vehicle sensors 22 may be utilized to acquire vehicle sensor data based on capture of images and/or audio, temperature, speed of the user, vehicles, streets, etc. as an end user travels/moves around. The system, apparatus 10, etc. may acquire such vehicle sensor data (via the vehicle sensors 22) and analyzes it along with other relevant data to determine a location of the user on a certain street, area, etc. It should be noted that various types of data such as end-user location data and battery/charge data may be detected via any functional means.

The data captured concerning end-user location data may also come from traffic cameras, security cameras, or any other functionally useful source (e.g., historic data, satellite images, websites, NFC data, Wi-Fi positioning, etc.).

The analysis of the image data, audio data, and other relevant data concerning end user location, etc. may be carried out by a machine learning (ML) model. The ML model may utilize any functionally useful means of analysis to identify end-user location data on a given roadway, road segment, building, or in a general area. The system, in this embodiment, may also examine relevant proximate points of interest (POIs), map objects, road geometries, animate/inanimate objects, etc., which could suggest potential end-user location data/information.

The locations of the user, their vehicle, any relevant points of interest (POIs), and other types of data which are utilized by various embodiments of the apparatus may each be identified in terms of latitudes and longitudes based on a location of the end user and their vehicle. In an example, a GPS sensor may be used to identify the location of the end user's device (e.g., smart phone, smart watch, tablet, etc.) and/or the end user vehicle (e.g., an EV, a truck, a car, a bus, etc.). The POIs, map objects, infrastructure, etc. identified by the system may also be detected via the vehicle sensors 22.

In certain embodiments, information detected by the one or more cameras or other sensors (of the vehicle sensors 22) may be transmitted to the apparatus 10, such as the processing circuit 12, as image data and/or audio data. The data transmitted by the one or more cameras, microphones, etc. can be transmitted via one or more wired communications and/or one or more wireless communications (e.g., near field communication, or the like). In some environments, the communication interface 16 can support wired communication and/or wireless communication with the vehicle sensors 22 (e.g., the one or more cameras, etc.).

The database 24 may be stored or cached on a device such as the apparatus 10 or any system. The database 24 may receive data associated to location, metadata, recommendations, climate, and various statistics. The database 24 may be hosted on multiple servers at the same or different locations. Operations of the database 24 may be executed using hardware including a processor, a microprocessor (e.g., to perform or control performance of one or more operations), a field-programmable gate array (FPGA), or an application-specific integrated circuit (ASIC). In some other instances, the database 24 may be implemented using software.

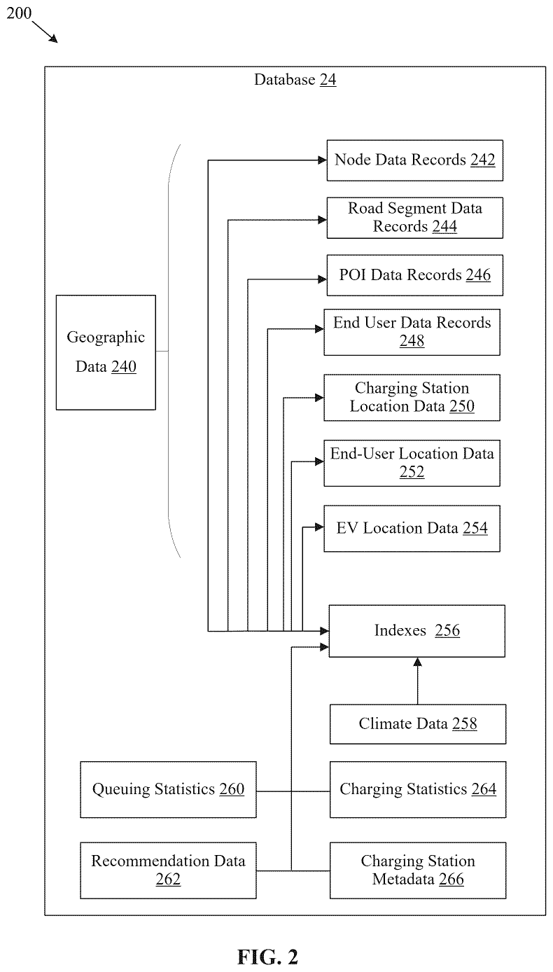

Turning to FIG. 2, the database 24 as shown in the exemplary scenario 200 may be a map or geographic or locational database that may include various types of geographic data 240. This geographic data 240 may include but is not limited to node data records 242, road segment data records 244, map object and point of interest (POI) data (also referred as POI data records 246), end user data records 248, charging station location data 250 (location data of chargers), end-user location data 252 (location data for end users/clients), EV location data 254, climate data 258, etc. The other data records may include queuing statistics 260, recommendation data 262, charging statistics 264, and the like. Additionally, the other data records may also include charging station metadata 266 (EVSE/charger metadata) about the charging station such as maximum theoretical charging capabilities, instantaneous charging capabilities, etc. End user preference data may also be accounted for in one or more databases. For example, preferred charging settings, time, level, etc. (see end user data records 248).

In one embodiment, the following terminology applies to the representation of geographic features in the database 24. A “Node”—is a point that terminates a link, a “road/line segment”—is a straight line connecting two points., and a “Link” (or “edge”) is a contiguous, non-branching string of one or more road segments terminating in a node at each end. In one embodiment, the database 24 follows certain conventions. For example, links do not cross themselves and do not cross each other except at a node. Also, there are no duplicated shape points, nodes, or links. Two links that connect each other have a common node.

The database 24 may also include cartographic data, routing data, and/or maneuvering data as well as indexes 256. In an example, the indexes 256 may be look-up tables storing pointers to information (e.g., the geographic data 240 and the climate data 258) stored in the database 24. According to some example embodiments, the road segment data records 244 may be links or segments representing roads, streets, or paths, as may be used in calculating a route or recorded route information for determination of one or more personalized routes. The node data (for example, the node data records 242) may be end-points (e.g., intersections) corresponding to the respective links or segments of road segment data records 244. The road link data (for example, the road segment data records 244) and the node data (for example, the node data records 242) may represent a road network, such as used by vehicles, cars, trucks, buses, motorcycles, bikes, scooters, and/or other entities. Data may flow freely between the geographic data 240 and the indexes 256 as needed (or restricted as needed).

Optionally, the database 24 may include the road segment data records 244 and the node data records 242 or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, EV charging stations, hotels, restaurants, museums, stadiums, offices, auto repair shops, buildings, stores, parks, etc. The database 24 can include data about the POIs and their respective locations in the POI data records 246. The database 24 may include data about places, such as cities, towns, or other communities, and other geographic features such as bodies of water, mountain ranges, etc. Such place or feature data can be part of the POI data records 246 or may be associated with POIs or POI data records 246 (such as a data point used for displaying or representing a position of a city). In addition, the database 24 can include event data (e.g., traffic incidents, construction activities, scheduled events, unscheduled events, etc.) associated with the POI data records 246 or other records of the database 24 (for example, a geographic database).

The database 24 may be maintained by a content provider, e.g., a map data service provider, and may be accessed, for example, by a content or service provider processing server. By way of example, the map data service provider can collect geographic data and dynamic data to generate and enhance the database 24 and dynamic data such as traffic-related data included therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as mobile device, as they travel the roads throughout a region.

The database 24 may be a master map database, such as a high definition (HD) map database, stored in a format that facilitates updates, maintenance, and development. For example, the database 24 may be a master database in which data can be stored in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, the geographic data 240 may be compiled (such as, into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by a mobile device, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received database in a delivery format to produce one or more compiled navigation databases.

As mentioned above, the database 24 may be a master geographic database, but in alternate embodiments, a client-side database may represent a compiled navigation database that may be used in or with end user devices to provide navigation and/or map-related functions. For example, the database 24 may be used with the mobile device to provide an end user with navigation features. In such a case, the database 24 can be downloaded or stored on the end user device which can access the database 24 through a wireless or wired connection, such as via a processing server and/or a network, for example. It should be noted the database 24 may also include data regarding the interiors of buildings, homes, offices, etc. to aid the system, apparatus 10, etc. in tracking end user location as the end user moves around one location or between locations.

The end user data records 248 may include various points of data such as, but not limited to, the end-user location data 252 (at a first location, a second location, etc.), end user payment data, charging need and preference data, end user driving profile data (e.g., driving tendencies, preferences, etc.), data concerning a user's typical travel routine, and other end user data useful for determining if an end user will likely use a proximate EV charger. The manner by which the apparatus 10 records and stores data may vary, and the examples discussed herein are non-limiting. It should be noted that the end-user location data 252 may also be a separate record from the end user data records 248.

The end-user location data 252 may, in some embodiments, include data obtained from GNSS, GPS, NFC, Wi-Fi triangulation, cellular tower information, micro-mobility data, image data of the end user, radio map data, etc. It should be noted that throughout this disclosure, end-user location data may include location data of an end user and/or their end user device(s) or vehicle(s). In some situations, it may be more useful to track end user location generally or track specific location of an end user device or vehicle. For example, if an end user exits their vehicle at a charging location, it may be more useful to track the location of their EV than the location of the mobile phone. Such determination may be made in real time by the system in some embodiments.

The geographic data 240 may further include charging station location data 250, which may be described as the geographical location of the charging station along with a current timestamp. Further, the end-user location data 252 may be associated with the positioning of an end user associated with an EV. The end-user location data 252 may include a current geographical location of the end user associated with the EV, and a current timestamp at the current geographical location. The location data of other end users may also be tracked in one or more embodiment, including a first end user, a second end user, a third end user, etc. The location data may, in some embodiments, include data obtained from GNSS, GPS, NFC, Wi-Fi triangulation, cellular tower information, micro-mobility data, image data of the end user, radio map data, etc. It should be noted that throughout this disclosure, end-user location data 252 may include location data of an end user and/or their end user device(s).

The geographic data 240 may also include the EV location data 254 that may be associated with the positioning of the EV associated with an end user. The EV location data 254 may include a current geographical location of the EV, and a current timestamp at the current geographical location. The location data of other EVs (including a first EV, a second EV, third EV, etc.) may also be tracked in one or more embodiments. The location data may, in some embodiments, include data obtained from GNSS, GPS, NFC, Wi-Fi triangulation, cellular tower information, micro-mobility data, image data of the end user, radio map data, etc. It should be noted that throughout this disclosure, the EV location data may include location data of the EV and/or the end user's device(s) or vehicle(s) internal systems.

It should also be noted that the end-user location data 252 and the EV location data 254 may be same when the end user is driving the EV and may be different when the end user is at a distance or is away from their associated EV. Further, the EV location data 254 and the end-user location data 252 may be interchangeably used when the EV location data 254 and the end-user location data 252 are the same or within a small distance (e.g., 1 meter).

The geographic data 240 may also include the climate data 258. The climate data 258 may be associated with the weather conditions at one or more charging stations. The climate data 258 may, in some embodiments, include data obtained from weather stations, satellites, historic climate data, remote sensing, weather monitoring services, probe data, etc.

The database 24 may also include the queuing statistics 260, the recommendation data 262, the charging statistics 264, and the charging station metadata 266. The queuing statistics 260 may refer to data or metrics used for analyzing and evaluating the performance of an EV charging infrastructure including a single or plurality of charging stations, a single or plurality of charging points, a single or plurality of charge cords, etc. The queuing statistics 260 may be determined based on the queuing time for a single charging station in real time as well as the queuing times for other charging stations (of a plurality of charging stations). The queuing statistics 260 may help in understanding the efficiency, capacity, and overall performance of charging stations for the apparatus 10. The queuing statistics 260 may include location-specific queuing times, charger-specific queuing times, charging capacity-specific queuing times, time-of-day-specific queuing times, and/or month-specific queuing times. This queuing statistics 260 (data) may be generated in real time, predicted by way of statistical analysis or machine learning, or any functional means. The queuing statistics 260 (data) may also be aggregated and used to generate predicted wait time of charging points which do not have real time communication with the apparatus 10.

The recommendation data 262 may refer to the information for the end users based on the queuing statistics 260 or the charging statistics 264, user preferences, behaviors, and interactions amongst other data points. The recommendation data 262 may include various types of information such as, indicating the given charging station as a recommended charging station (based on the queuing time of the charging station) for charging of an EV. Other types of recommendations might also be made indicating a recommended charging capacity at the charging station, and recommendation data for a charging station search-provider or a charging station routing-provider based on the charging station information and the queuing time for the charging station.

The charging statistics 264 may refer to as data or metrics related to the usage, availability, and performance of charging stations for the EVs. The charging statistics 264 may help to understand information on the plurality of charging stations, types of chargers, frequency of use, user preferences, and the growth and distribution of charging infrastructure across different regions and sectors. Further, the charging statistics 264 may be useful to ascertain the trends, challenges, and advancements in the charging ecosystem. The charging statistics 264 may be determined based on the charging time for the charging station and charging times for other charging stations of the plurality of charging stations of the EV charging infrastructure. Further, the charging statistics 264 includes location-specific charging times charger-specific charging times, charging capacity-specific charging times, time-of-day-specific charging times, and/or month-specific charging times.

The charging station metadata 266 may refer to descriptive information that helps to organize, find, and understand primary data, such as, characteristics related to the charging station. The charging station metadata 266 may include various types of information, such as the content, context, quality, condition, and other characteristics of the charging station. For example, the charging station metadata 266 associated with the charging station may include at least one of, a number of operational charging points at the charging station, a charger power output associated with each of the operational charging points, an availability of a fast-charging point among the charging points, power sharing capabilities, or a charging time required for one or more EV models.

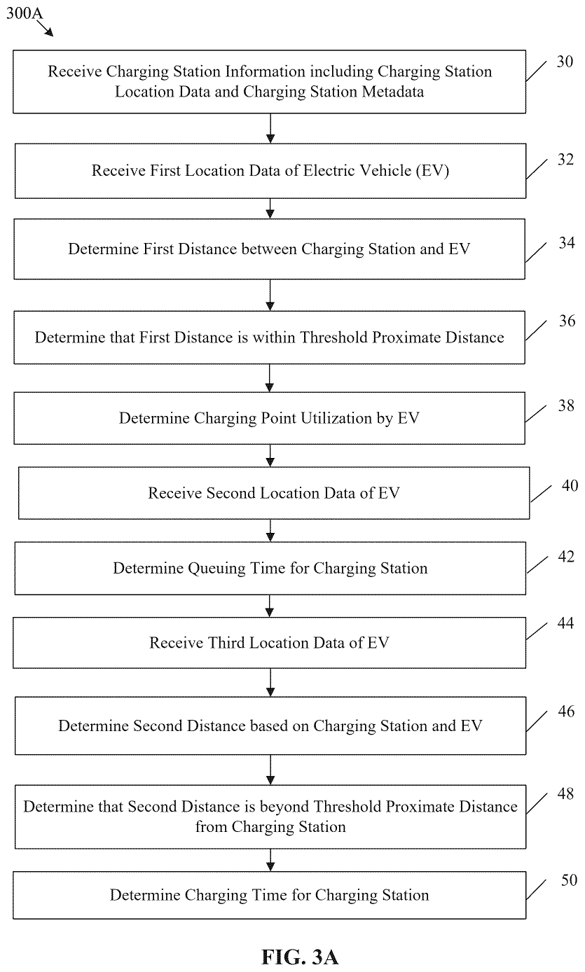

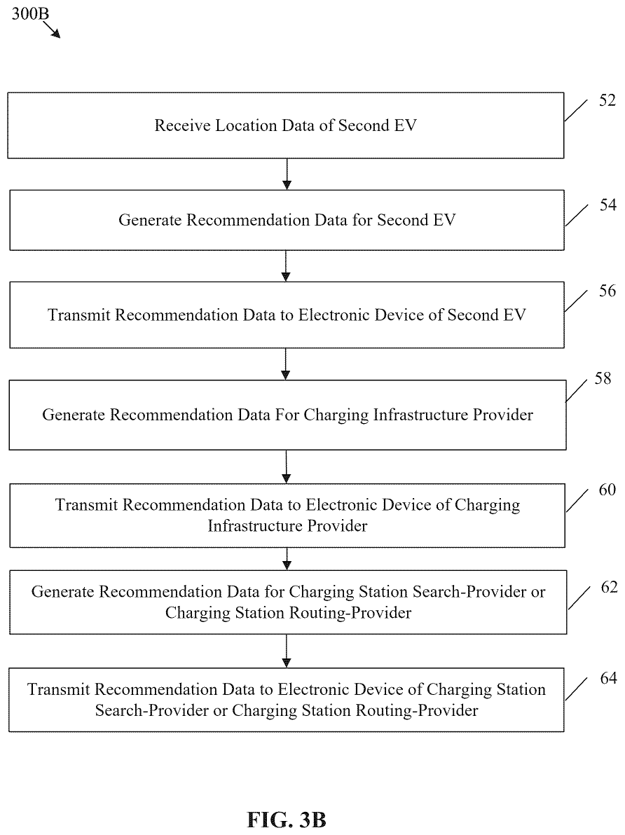

Turning to FIG. 3A, the operations performed, such as, by the apparatus 10 of FIG. 1, in order to determine queuing time and charging time based on received charging station information and locations associated with an EV, are described in a flowchart 300A. More, fewer, or different acts or steps may be provided in the flowchart 300A. At a first step (at block 30), the apparatus 10 may receive charging station information. The charging station information may include the charging station location data 250 and the charging station metadata 266 of the charging station. The charging station location data 250 may be the geographical location of the charging station and the current timestamp at the geographical location of the charging station. The charging station location data 250 may be obtained from various programs, apps, websites, etc., running on said end user device such as location guidance apps (e.g., Google Maps, Here We Go, etc.), satellite, messaging apps, GNSS, GPS, NFC, Wi-Fi triangulation, cellular tower information, micro-mobility data, image data of the end user, radio map data, etc. The determination of the current timestamp may include a system clock associated with the charging station that keeps track of the current date and time and the system clock synchronization with external time source using protocols such as a Network Time Protocol (NTP) or a Precision Time Protocol (PTP) for higher accuracy. The charging station metadata 266 may include at least one of, but not limited to, a number of operational charging points at the charging station, a charger power output associated with each of the operational charging points, an availability of a fast-charging point among the charging points, or a charging time required for one or more EV models.

Further, the apparatus 10 may receive the end-user location data 252 (or the EV location data 254) of an EV at a second step (at block 32). This end-user (or EV) location data may be associated with an end user or the EV and may be termed as the end-user location data 252 or the EV location data 254, wherein the end user may be a user operating a device inside an EV, a human user, a software client, mobile device, etc. that helps with the positioning of the EV. The end-user location data 252 (or the EV location data 254) of an EV may be determined based on at least one of Global Positioning System (GPS) data associated with the EV, Global Navigation Satellite System (GNSS) data associated with the EV, and/or vehicle sensor data associated with the EV. In an example, the end-user location data 252 (or the EV location data 254) may be captured using the positioning sensor 20 and/or the vehicle sensors 22. The end-user location data 252 (or the EV location data 254) may include the current geographical location of the EV, and the current timestamp at the current geographical location. It should be noted that in some embodiments, the end user location and EV location data may vary (e.g., if a user exits the vehicle, then the end-user location data 252 may be different from the EV location data 254). In such a situation it should be understood that the apparatus 10 may accommodate any location data useful for calculating charger wait times.

The charging station location data 250 (charger's location data) and the end-user location data 252 and/or the EV location data 254 may be used to determine a distance (e.g., a first distance) between the charging station and the EV at a third step (at block 34). The first distance may be determined as any (e.g., a straight-line) distance between a location of the charging station and a location of the EV. In another scenario, the first distance may be determined as the shortest driving distance between the location of the charging station and the location of the EV. The shortest driving distance may be determined based on the mapping system and/or the map data stored on the database 24.

The apparatus 10 may further determine (at block 36) that the distance (e.g., the first distance) between the charging station and the EV is within a threshold proximate distance. The threshold proximate distance may be referred to a specific distance value used as a criterion to determine whether two or more objects or points are considered to be “close” or “near” to each other. For example, the threshold proximate distance may be 50, 20, 10 meters, etc. The threshold proximate distance may be defined in different contexts, including a geographical proximity, sensor proximity, route proximity and the like. The specific value of the threshold proximate distance may depend on the application and the level of sensitivity or precision required by the apparatus 10.

The apparatus 10 may then determine (at block 38) the charging point utilization by the EV. The charging station may include one or more charging points. Each of the one or more charging points may include charging equipment, such as, a power supply unit, a charging connector and cable, a metering unit, and the like. The EV may utilize the charging point to re-charge its battery(s) (or battery pack(s)). The apparatus 10 may determine whether the EV is currently utilizing at least one of the charging points of the charging station. To confirm an EV is interacting with the charging point of the charging station, second location data for the EV may be recorded by the apparatus 10 as discussed above (e.g., GPS and/or sensor data). If the EV has moved very close (for e.g., within 1 meter) to the charging station as compared to its first recorded location (i.e. the first location data), it can be inferred that the end user is using the one of the charging points of the charging station. The charging point utilization by a given EV within a distance threshold might also be confirmed by feedback from the EV's internal systems and/or CPO operator data (e.g., positive confirmation of use in real time or nor real time). The EV's internal system may include but not limited to, electronic control units (ECUs), integrating vehicle control units (VCUs), battery management system (BMS), Motor Control Unit (MCU), and the likes.

The utilization of the charging point may be determined to measure the frequency of use and efficiency of charging point over a specific period. The utilization may be determined for understanding the efficiency, demand, and performance of the charging station as a whole.

The apparatus 10 may also receive (at block 40) the second location data of the EV based on the determination that the EV is utilizing the charging point of the charging station. The second location data may be associated with the positioning of the EV when utilizing the charging point of the charging station. The second location data may be determined based on at least one of Global Positioning System (GPS) data associated with the EV, Global Navigation Satellite System (GNSS) data associated with the EV, or vehicle sensor data associated with the EV. The second location data may include the current geographical location of the EV utilizing the charging point, and the current timestamp at the current geographical location. It should be noted that the EV charger use and the second location data for a given EV in this context may be interchangeable and confirmation of use might also come from charge point operator data. Put another way, the EV second location data point may suggest usage and/or the EVSE usage data may suggest or confirm the second location data point.

The apparatus 10 may then determine (at block 42) the queuing time for the charging station based on at least in part on the charging station location data 250, the end-user location data 252 (and/or the EV location data 254) and the charging station metadata 266 of the charging station. For example, the location of an EV may be noted by the apparatus 10 as 30 meters from the location of the charging station. The EV may be situated at this location at a certain time (for example 11.05.00 AM). The EV may move to another location at a later time (for example 11.25.00 AM, referred hereinafter as a second timestamp), as captured by the apparatus 10. This location may coincide with or may be near the location (as per the charging station location data 250) of the charging point of the charging station. The apparatus 10 may determine a time difference between second timestamp and the first timestamp to determine an estimate of the queuing time at the charging station. In this example, the queuing time may be estimated as 20 minutes (i.e., the difference between 11.25.00 AM and 11.05.00 AM).

The charging station metadata 266 may be used to refine this estimate of the queueing time. In an embodiment, the apparatus 10 may also receive the climate data 258 associated with the charging station location data 250. The climate data 258 may also be utilized in the determination of the queuing time. Alternatively, the estimation of the queuing time may be based on the queuing statistics 260. For example, the queuing statistics 260 along with the climate data 258 is given in the following Table1:

TABLE 1

| | | | Time- | | |
|---|---|---|---|---|---|
| Location- | Charger- | Charging | of-day- | Month- | |
| Specific | Specific | Capacity | Specific | specific | |
| Queuing | Queuing | Queuing | Queuing | Queuing | Climate |
| Time | Time | Time | Time | Time | Data |
| 20 min | 35 min | 15 min | 40 min | 20 min | Rainy Day |
| 10 min | 10 min | 15 min | 5 min | 10 min | Sunny Day |

Herein, the queuing time based on the specific location on a rainy day may be 20 minutes and on a sunny day may be 10 minutes. Similarly, the queuing time based on the specific charger on a rainy day may be 35 minutes and on a sunny day may be 10 minutes, and so on. It should be noted that the data shown in the Table 1 is for exemplary purposes and should not be construed to limit the scope of the disclosure.

In another embodiments, the apparatus 10 generates an automated vehicle control signal based at least in part on the queuing time of the charging station.

The presently disclosed system, apparatus 10, etc. may monitor, track, etc. the location of an end user at various locations throughout the day, when the plurality of EVs travel is within or beyond the threshold proximate distance from the charging station.

In another embodiment, the apparatus 10 may compute, e.g., the queuing statistics 260, based on mean, median, variance and/or maximum of the queueing time for each charging point of a given charging station. For example, if an end user of the EV drives down a roadway on a given day, then the apparatus 10 may track this EV's location when a battery level drops below a certain level (for example, 20%). Once, the battery level of the EV is below the certain level, the apparatus 10 may utilize GNSS data, image data, etc. to determine the EV's location with a high degree of accuracy.

Once the EV location has been identified, the apparatus 10 may then determine one or more charging stations which the EV may be traveling near or towards. The location of the charge station may be determined based on the threshold proximate distance such as within a predefined distance (e.g., 50 meters) or dynamically determined based on surrounding POIs, etc. For example, if the EV is driving down a rural roadway the nearest charging station might not be for several miles and thus the apparatus 10 may adjust the threshold proximate distance in such a situation. Factors such as remaining battery charge, fuel levels (in hybrid cars), queueing time for each charging station of the plurality of charging stations etc. may also be used by the apparatus 10 for determining the charging station.

In another embodiment, the apparatus 10 may utilize the first location data of the EV, the second location data of the EV, and the charging station metadata 266 of the charging station to determine the queuing time for EVs other than the EV (which may be currently utilizing the charging point of the charging station). For example, the determined queuing time may be determined as 10 minutes for other EVs, when the EV (for example, the EV 404) is utilizing the charging point of the charging station.

The apparatus 10 may determine the overall charging time based on the received location data (i.e., the first location data, second location data, and third location data) associated with the EV, and the charging station metadata 266 of the charging station. At a step (at block 44), the apparatus 10 may receive the third location data (similar to, the first location data or the second location data) of the EV. The third location in this example represents the EV exiting the charge station, opening it for use by another EV.

The third location data may be associated with the positioning of the EV determined based on at least one of Global Positioning System (GPS) data associated with the EV, Global Navigation Satellite System (GNSS) data associated with the EV, or vehicle sensor data associated with the EV. The third location data may include the current geographical location of the EV, and the current timestamp at the current geographical location. Further, the charging station metadata 266 associated with the charging station may include at least one of, a number of operational charging points at the charging station, a charger power output associated with each of the operational charging points, an availability of a fast-charging point among the charging points, or a charging time required for one or more EV models.

The apparatus 10 may determine (at block 46) the subsequent second distance between the EV and the charging station (e.g., a post charge distance). The charging station location data 250 and the third location data may be used to determine the second distance between the charging station and the EV. The distance may be determined as a straight-line distance between a location (as per the charging station location data 250) of the charging station and a location (as per the third location data) of the EV. In another scenario, the second distance may be determined as the shortest driving distance between the location of the charging station and the location of the EV. The shortest driving distance may be determined based on the mapping system of the EV and/or the map data stored on the database 24.

The apparatus 10 may further determine (at block 48) that the post charge distance (e.g., the second distance) is beyond the threshold proximate distance from the charging station. In an embodiment, the apparatus 10 may receive the third location data based on determination that the second distance of the EV from the charging station is beyond the threshold proximate distance. Further, the apparatus 10 may determine (at block 50) the charging time for the charging station based on at least in part on the second location data (the location when EV charging begins), the charging station location data, the third location data (the location of the EV leaving the station), and the charging station metadata 266 of the charging station.

In some embodiments, the charging station metadata 266 may be used to refine the estimate of the wait times and/or charging times. In an embodiment, the apparatus 10 may also receive the climate data 258 associated with the charging station location data 250. The climate data 258 may also be utilized in the determination of the wait time or charging time. Alternatively, the estimation of the charging time may be based on the charging statistics 264. Examples of charging statistics 264 along with the climate data 258 are given in the following Table 2:

TABLE 2

| | | | Time- | | |
|---|---|---|---|---|---|
| Location- | Charger- | Charging | of-day- | Month- | |
| Specific | Specific | Capacity | Specific | specific | |
| Charging | Charging | Charging | Charging | Charging | Climate |
| Time | Time | Time | Time | Time | Data |
| 30 min | 35 min | 35 min | 30 min | 20 min | Rainy Day |
| 20 min | 20 min | 15 min | 15 min | 5 min | Sunny Day |

Herein, the charging time based on the specific location on a rainy day may be 20 minutes and on a sunny day may be 30 minutes, Similarly, the queuing time based on the specific charger on a rainy day may be 35 minutes and on a sunny day may be 20 minutes, and so on. It should be noted that the Table 2 is for exemplary purposes and should not be construed to limit the scope of the disclosure.

In another embodiments, the apparatus 10 may generate an automated vehicle control signal based at least in part on the charging time of the charging station.

As the term used herein “charging time” referred to as a duration required to replenish the battery of an EV from a certain state of charge (SOC) to a desired level. This time can vary significantly based on several factors, including the type of charging equipment used, the capacity of the EV's battery, the initial state of charge, and the charging power available. The charging statistics 264 may include location-specific charging times associated with the plurality of charging stations, charger-specific charging times associated with the plurality of charging stations, charging capacity-specific charging times associated with the plurality of charging stations, time-of-day-specific charging times associated with the plurality of charging stations, or month-specific charging times associated with the plurality of charging stations. The charging time for the charging station may be determined based on estimation of the time using various factors such as charger-specific, capacity-specific, time-of-day-specific, or month-specific associated with the plurality of charging stations. In one embodiment, the apparatus 10 may compute e.g., the charging statistics 264, based on mean, median, variance and/or maximum of the charging time for each charging point of the charging station.

Turning to FIG. 3B, the operations performed, such as, by the apparatus 10 of FIG. 1, in order to provide recommendation data for an electronic device associated with an EV, are described in a flowchart 300B. More, fewer, or different acts or steps may be provided in the flowchart 300B. At a first step (at block 52), the apparatus 10 may receive location data of another EV (also referred to as the second EV). The location data of the second EV may be associated with the positioning of the second EV. The location data may be determined based on at least one of Global Positioning System (GPS) data associated with the second EV, Global Navigation Satellite System (GNSS) data associated with the second EV, or vehicle sensor data associated with the second EV. The location data may include the current geographical location of the second EV, and the current timestamp at the current geographical location.

The recommendation data 262 may include the recommendation data. The recommendation data may include recommendations associated with one or more charging stations from the plurality of charging stations, recommendations associated with a plurality of routes for the one or more charging stations, recommendations associated with the queuing time associated with each of the one or more charging stations, recommendations associated with a charging time associated with each of the one or more charging stations, and/or recommendations associated with climate at the one or more charging stations.

The apparatus 10 may generate the recommendation data indicating the charging station as a recommended charging station for charging of the EV. The recommendation data may be generated (at block 54) based at least on the end-user location data 252/EV location data 254, the charging station location data, and the queuing time for the charging station.

The apparatus 10 may further transmit (at block 56) the recommendation data to an electronic device associated with the second EV. The electronic device of the second EV may include suitable logic, circuitry, interfaces, and/or code that may be configured to receive or transmit data associated the second EV. The data associated with the second EV may include, but not be limited to, the node data records 242, the road segment data records 244, the map object or the POI data records 246, the end user data records 248, the end-user location data 252, the EV location data 254, the climate data 258, and the likes.

Further, the electronic device may be equipped with a user interface (UI) (such as, the user interface 18) that may receive the transmitted recommendation data from the apparatus 10. Examples of the electronic device may include, but are not limited to, a computing device, a smartphone, a cellular phone, a mobile phone, a gaming device, a mainframe machine, a server, a computer workstation, a machine learning device (enabled with or hosting, for example, a computing resource, a memory resource, and a networking resource), a wearable device with performance attribute detection sensor, a depth sensor device, and/or a consumer electronic (CE) device.

This recommendation data may be received via an end user device graphical user interface (GUI) running upon a smartphone, tablet, integrated vehicle navigation system, etc. Once the location of the second EV has been received as being within or close to the threshold proximate distance of any charging station of the plurality of charging stations, charge station, charge kiosk, Electric Vehicle Supply Equipment (EVSE), or any device capable of charging an EV; the apparatus 10 may generate and/or transmit the recommendation data to the second EV.

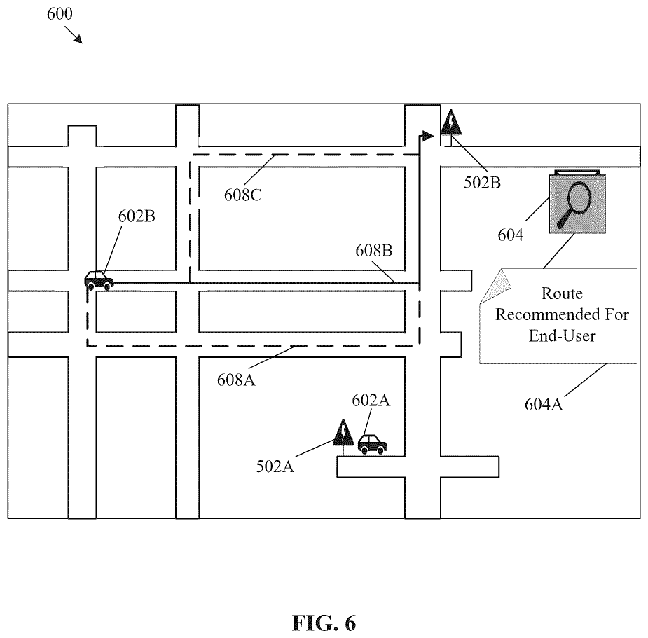

Further, the apparatus 10 may access the database 24 and determine a plurality of routes such as, a “Route 1”, a “Route 2”, or a “Route 3” (as shown, for example, in FIG. 6) and an estimated time based on the queuing and/or charging times associated with the charging station, for directing the end user (associated with at least one of the EV of the plurality of EVs) to the recommended charging station. Further, the UI of the electronic device may be rendered to display the recommendation data along with the plurality of routes such as, the “Route 1”, the “Route 2”, or the “Route 3”, and the estimated time. The UI may be configured to allow manual selection of a route from the plurality of routes by the end user. The apparatus 10 may take any number of additional actions (or in place of) apart from displaying the selected route to the end user. For example, the apparatus 10 may provide audio guidance instead of a visual display. Navigation instructions may also be provided to the second EV for routing (for example, with or without any display to the user), in case the second EV is an autonomous vehicle. It should also be noted the UI can be run by a processor and stored upon one or more types of memory in some embodiments.

In one embodiment, the apparatus 10 may utilize various data about the plurality of charging stations to suggest or automatically select one or more charging stations based on the queuing statistics, the charging stations, and the charging station metadata 266 associated with the charging station. This may be accomplished by considering data such as the current geographical location of the second EV and the current timestamp associated with the current geographical location of the second EV.

Referring to FIG. 3B, the operations performed, such as by the apparatus 10 of FIG. 1, in order to provide recommendation data for a charging infrastructure provider, and for a charging station search-provider or a charging station routing-provider, are described in the flowchart 300B. More, fewer, or different acts or steps may be provided in the flowchart 300B. At a first step (at block 30, refer FIG. 3A), the apparatus 10 may receive the charging station information and determine (at block 42, refer FIG. 3A) the queuing time for the charging station. Further, based on the charging station information and the queuing time for the charging station, the apparatus 10 may generate (at block 58, refer FIG. 3B) the recommendation data that may indicate a recommended charging capacity at the charging station.

The recommendation data 262 may include recommendations associated with several factors, including an intended use case, types of EVs, a location of the charging station, a charging capacity, an infrastructure of the charging station, and an expected demand. The recommended charging capacity may typically be measured in kilowatts (kW) and may vary widely based on a charging level. For example, the charging level may include a level 1 corresponding to slow charging with 1.4 kW to 1.9 kW (120V, 12-16 A) capacity, a level 2 corresponding to standard charging with 3.3 kW to 19.2 kW (240V, 16-80 A) capacity, a level 3 corresponding to DC fast charging with 50 kW to 350 KW (DC) capacity, and an ultra-fast charging with 350 kW or above (DC) capacity.

The apparatus 10 may further transmit (at block 60, refer FIG. 3B) the recommendation data to an electronic device associated with the charging infrastructure provider. The electronic device of the charging infrastructure provider may include suitable logic, circuitry, interfaces, and/or code that may be configured to receive or transmit data associated the charging infrastructure provider. The data associated with the charging infrastructure provider may include, but not be limited to, the types of EVs, the location of the charging station, the charging capacity, the infrastructure of the charging station, and the expected demand.

Further, the electronic device may be equipped with a user interface (UI) (such as, the user interface 18) that may receive the transmitted recommendation data from the apparatus 10. This recommendation data may be received via an end user device graphical user interface (GUI) running upon a smartphone, tablet, integrated vehicle navigation system, etc. Upon receiving the recommendation data, the charging infrastructure provider may be guided to install the recommended charging capacity at the charging station.

Further, the UI may be configured to allow manual selection of the level of charging from the plurality of levels of charging to be installed by the charging station or the charging infrastructure provider. The apparatus 10 may take any number of additional actions (or in place of) apart from displaying the required charging capacity to the charging infrastructure provider. For example, the apparatus 10 may provide audio guidance instead of a visual display, or the apparatus 10 may provide recommendation (or an advertisement) related to any new infrastructural development in the charging station apart from the recommendation data. It should also be noted the UI can be run by a processor and stored upon one or more types of memory in some embodiments. In one embodiment, the apparatus 10 may utilize various data about the recommended charging capacity to suggest or automatically select one or more installation required by the charging stations based on the queuing statistics, the charging stations, the charging station metadata 266 of the charging station, and the likes.

In another embodiment, the apparatus 10 may generate (at block 62, refer FIG. 3B) the recommendation data that may indicate the charging station as a recommended charging station to the charging station routing-provider.

The recommendation data 262 may include the recommendation data. The recommendation data may include recommendations associated with one or more charging stations from the plurality of charging stations, recommendations associated with a plurality of routes for the one or more charging stations, recommendations associated with the queuing time of each of the one or more charging stations, recommendations associated with the charging time of each of the one or more charging stations, and/or recommendations associated with climate at the one or more charging stations.

The apparatus 10 may further transmit (at block 64, refer FIG. 3B) the recommendation data to an electronic device associated with the charging station search-provider or the charging station routing-provider. The electronic device of the charging station search-provider or a charging station routing-provider may include suitable logic, circuitry, interfaces, and/or code that may be configured to receive or transmit data associated the charging station search-provider or a charging station routing-provider. The data associated with the charging station search-provider, or a charging station routing-provider may include, but not be limited to, routing data associated with the recommended one or more charging stations.

The recommendation data may be received via an end user device graphical user interface (GUI) running upon a smartphone, tablet, integrated vehicle navigation system, etc. Further, the apparatus 10 may access the database 24 and determine a plurality of routes such as, the “Route 1”, the “Route 2”, or the “Route 3” (as shown in FIG. 6) and an estimated time based on the queuing and charging time associated with the charging station, for directing the end user (associated with at least one of the EV of the plurality of EVs) to the recommended charging station. Further, the UI of the electronic device may be rendered to display the recommendation data along with the plurality of routes such as, “Route 1”, “Route 2”, or “Route 3”, and the estimated time. It should also be noted the UI can be run by a processor and stored upon one or more types of memory in some embodiments.

In one embodiment, the apparatus 10 may utilize various data about the plurality of charging stations to suggest or automatically select one or more charging stations based on the queuing statistics, the charging stations, and the charging station metadata 266 associated with the charging station. This is accomplished by considering data such as current location of the EV of the plurality of EVs and the current timestamp associated with the current location of the EV.

It should be noted that the routing suggestions may, in some embodiments, be directly provided to various end users (e.g., EVs, end users on their smartphones, etc.).

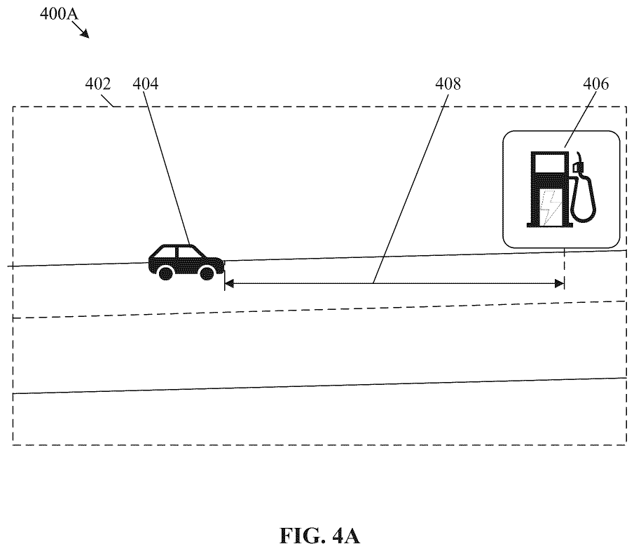

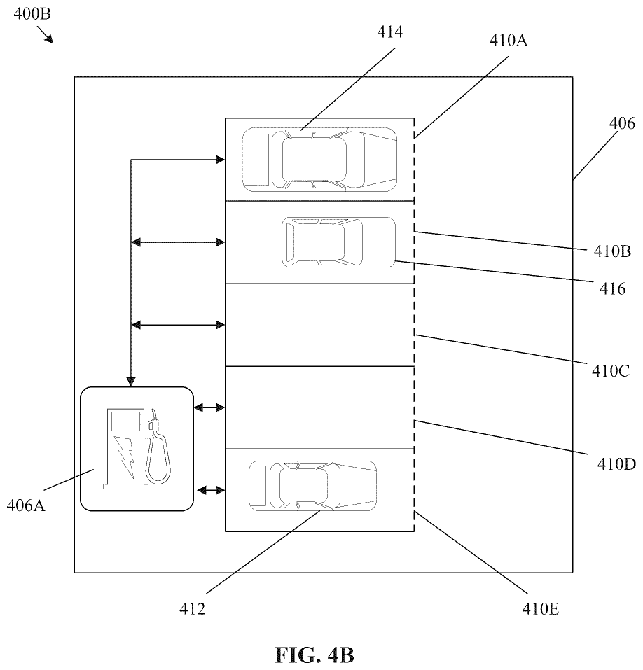

Turning to FIG. 4A, a scenario diagram 400A of a charging station and an EV of some of the examples discussed above is illustrated. The scenario diagram 400A shows a graphical representation of an example scenario including a location of a charging station and a location of an EV 404 (also referred to as a first EV) approaching the charging station. Specifically, the scenario shows a road segment 402 including the EV 404 approaching a charging station 406. The EV 404 may utilize the apparatus 10 (e.g., an electronic device associated with the EV 404 or the end user) to determine the queuing time for the charging station 406. The apparatus 10 may receive the charging station location data 250, and the charging station metadata 266 of the charging station 406 via GNSS data. The apparatus 10 may also receive the second location data of the EV 404 via GNSS data and/or sensors data from the vehicle sensors 22 (or other security cameras, traffic cameras, etc.) and determine a distance 408.

The charging station location data 250 and the end-user location data 252 and/or the EV location data 254 (for example, the first location data of the EV 404) may be used to determine the distance 408 (e.g., a first distance) between the charging station and the EV 404. The distance 408 may be determined as a straight-line distance between a location (as per the charging station location data 250) of the charging station and a location (as per the first location data, for example, the end-user location data 252 or the EV location data 254) of the EV 404. In another scenario, the distance 408 may be determined as a shortest driving distance between the location of the charging station and the location of the EV 404. The shortest driving distance may be determined based on the mapping system of the EV 404 and/or the map data stored on the database 24.

The apparatus 10 may receive the first location data (the end-user location data 252 and/or the EV location data 254) of the EV 404 based on a determination that the distance 408 is within a threshold proximate distance (for example, 50 meters). The apparatus 10 may then determine the utilization of the charging point of the charging station 406 by the EV 404. When the apparatus 10 determines that the charging point of the charging station is being utilized by the EV 404, then the apparatus may receive the second location data (like the first location data) of the EV 404. Further, the apparatus 10 may determine the queuing time for the charging station 406 based on the first location data, the second location data, and the charging station metadata 266. In an embodiment, the apparatus 10 may also receive the climate data 258 associated the charging station location data 250. Further, the apparatus 10 may determine the queuing time for the charging station 406, based on the climate data 258. Herein, the apparatus 10 may record the second location of the EV to confirm that the EV 404 is interacting with the charging station 406 as discussed above. The apparatus 10 may record the second location using GPS, sensor data, etc. If the EV has moved very close (for e.g., within 1 meter) to the charging station 406 as compared to the first location of the EV (its first recorded location), it may be inferred that the end user and/or the EV may be utilizing the charging station 406. Additionally, the charging point utilization by a given EV (the EV 404) within the distance proximity threshold might also be confirmed by feedback from the EV's (the EV 404) internal systems and/or CPO operator data (for e.g., positive confirmation of use in real time or nor real time).

It should be noted that the EV 404 in this example may represent any vehicle. Such vehicles may be standard gasoline powered vehicles, hybrid vehicles, other EVs, a fuel cell vehicle, and/or any other mobility implement type of vehicle (e.g., bikes, scooters, etc.). The vehicle includes parts related to mobility, such as a powertrain with an engine, a transmission, a suspension, a driveshaft, and/or wheels, etc. The vehicle may be a non-autonomous vehicle, assisted driving vehicle, or an autonomous vehicle. The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands. In one embodiment, the vehicle may be assigned an autonomous level. An autonomous level of a vehicle can be a Level 0 autonomous level that corresponds to a negligible automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

In one embodiment, a graphical user interface (GUI) may be integrated in the electronic device of the EV 404, which may include assisted driving vehicles such as autonomous vehicles, highly assisted driving (HAD), and advanced driving assistance systems (ADAS). Any of these assisted driving systems may be incorporated into the GUI. Alternatively, an assisted driving device may be included in a vehicle (e.g., the EV 404). The assisted driving device may include memory, a processor, and systems to communicate with the GUI. In one embodiment, the vehicle may be an HAD vehicle or an ADAS vehicle. An HAD vehicle may refer to a vehicle that does not completely replace the human operator. Instead, in a highly assisted driving mode, a vehicle may perform some driving functions, and the human operator may perform some driving functions. Such vehicle may also be driven in a manual mode in which the human operator exercises a degree of control over the movement of the vehicle. The vehicle may also include a completely driverless mode. The HAD vehicle may control the vehicle through steering or braking in response to the position of the vehicle and may respond to lane marking indicators (lane marking type, lane marking intensity, lane marking color, lane marking offset, lane marking width, or other characteristics) and driving commands or navigation commands. Similarly, ADAS vehicles may include one or more partially automated systems in which the vehicle alerts the driver. The features may be designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands. The automated controls may also specifically interact with an automated charge point to enable automated charging.

In an example, the end user of the EV 404 may not have an EV charger at their home thus may routinely visit a charging station nearby. Based on the end user starting from a location (e.g., home or office) with a charge of the EV 404 being below 50%, the apparatus 10 may deduce that the end user of the EV 404 may be likely going to charge their EV (i.e., the EV 404) at a given charging point (such as, the charging point of the charging station 406). Additionally, if the all the charging points of the charging station 406 are being utilized by other EVs and are thus unavailable for a time period, then the apparatus 10 may determine the queuing time for the charging station 406, based on the second location data of the EV 404, location data of each EV of the other EVs, the climate data 258 of the location of the charging station 406, and the charging station metadata 266 of the charging station 406. For example, the queuing time determined by the apparatus 10 on a sunny day may be 15 minutes for the charging station 406 and on a rainy day may be 35 minutes for the charging station 406. Further, the apparatus 10 may generate recommendation data indicating another charging station, which may be nearby, as a recommended charging station for charging of the EV 404. Then, the apparatus 10 may transmit the recommendation data to the electronic device of the EV 404. The recommendation data may be rendered on the GUI of the electronic device of the EV 404, guiding the user of the EV 404 to route to the recommended charging station.

In some embodiments, the apparatus 10 may receive the charging station information including the charging station location data 250 and the charging station metadata 266. In one embodiment, the apparatus 10 may use one or more databases (for example, the database 24, see FIG. 2) to extract desired information associated with the charging station 406 and generate recommendation data for nearest charging stations, required charging capacity, and/or a plurality of routes associated with the nearest charging stations.

Alternatively, or additionally, in an embodiment, the EV 404 may utilize the apparatus 10 to determine the charging time for the charging station 406. The apparatus 10 may receive the charging station location data 250 via GNSS data, and the charging station metadata 266. The apparatus 10 may also receive third location data of the EV 404 via GNSS data and/or sensors data from the vehicle sensors 22 (or other security cameras, traffic cameras, etc.) and determine a second distance (like the distance 408). The second distance may be a distance between the location (as per the first location data) of the charging station 406 and the location (as per the third location data) of the EV 404.

The apparatus 10 may receive the third location data of the EV 404 based on a determination that the second distance is beyond the threshold proximate distance (e.g., leaving the charge station). The apparatus 10 may then determine the utilization of the charging point of the charging station 406. When the apparatus 10 determines that the charging point of the charging station is not being utilized by any EV, then the apparatus 10 may determine the charging time for the charging station 406, based on the second location data of the EV 404 (or the charging station location data 250) the third location data of the EV 404, and the charging station metadata 266 of the charging station 406. In an embodiment, the apparatus 10 may receive the climate data 258 associated with the charging station location data 250 to determine the charging time for the charging station 406.

In this example, the end user of the EV 404 does not have an EV charger at their home thus may routinely visit the charging station nearby. Based on the end user starting from a location (e.g., home or office) with a charge of the EV 404 being below 50%, the apparatus 10 may deduce the user of the EV 404 is likely going to go charge their EV at the given charging point. Additionally, if at least one of the charging points of the charging station 406 may be available for utilization of the EV 404, then the apparatus 10 may determine the charging time for the charging station 406, based on the third location data of the EV 404, climate data 258 of the charging station location data 250, and the charging station metadata 266. Herein, the second location data of the EV 404 may be taken into account (and approximated as the first location data) when the second distance or the distance 408 is within the threshold proximate distance. For example, the charging time determined by the apparatus 10 on a sunny day may be 15 minutes for the charging station 406 and on a rainy day may be 35 minutes for the charging station. Further, the apparatus 10 may generate recommendation data indicating another charging station nearby as a recommended charging station for charging of each of the other EVs based on the determined charging time. Further, the apparatus 10 may transmit the recommendation data to the electronic device of each of the other EVs. The recommendation data may be rendered to display on the electronic device of each of the other EVs, guiding the user of each of the other EVs to route to the recommended charging station.

The apparatus 10 may provide to the electronic device of the EV 404 (or any other EV) recommendation, feedback, alerts, suggestions, etc. In some embodiments, this recommendation might be computerized instructions which cause one or more software programs and/or devices to change one or more settings to create signals for autonomous driving control. The information may also be used to provide route guidance to avoid certain charging station due to power constraints, etc. Alerts, settings updates, and routing information may also be provided to other user(s) in the area.

The recommendation data generated may also be used to select a preferred set of charging station. For example, some users of the EVs may wish to charge their EV as fast as possible. If a local charger or supercharger is typically not in use overnight, the apparatus 10 may note this location a preferred due to the ability to charge quickly with likely drop off in charging time or queuing time.

It should also be noted in some examples that the apparatus 10, system, etc. may monitor charging station availability in addition to determining the queuing time and the charging time associated with the charging station 406. In some cases, the charging points of the charging station 406 may be occupied for longer stretches making them less useful to recommend to the EVs within the threshold proximate distance who needs immediate charging. Such data may be obtained and monitored by apparatus 10 in real-time from the charging station search-provider or a charging station routing-provider, the vehicle sensors 22, charging stations, camera systems, etc.

Turning to FIG. 4B, a scenario diagram 400B including a charging lot of a charging station of some of the examples discussed above is illustrated. The scenario diagram 400B is a graphical representation of an example scenario including a charging lot of the charging station 406 (of FIG. 4A) within which the apparatus 10 may be in use. Specifically, an EV 412 is shown driving down a roadway toward the charging station 406. As shown in FIG. 4B, the charging station 406 may include a plurality of charging points 410 (such as, a first charging point 410A, a second charging point 410B, a third charging point 410C, a fourth charging point 410D, and a fifth charging point 410E). Each charging point of the plurality of charging points 410 may be connected with a power supply 406A that may further be connected with a power grid (outside the charging station 406, not shown in the FIG. 4B). In an embodiment, each charging point of the plurality of charging points 410 may include a plurality of charging types, a plurality of charging plugs, and the likes, which may be compatible with a plurality of types, model, and makes of EV.

In this example, the EV 412 has navigated to the charging station 406 based on the recommendation data on the electronic device of the EV 412. Further, the EV 412 may be utilizing the fifth charging point 410E as shown in the FIG. 4B. Also, for example, before the EV 412 plugs into the fifth charging point 410E, a battery level of the EV 412 may be 10%. Further, the apparatus 10 may also determine a type of charging point required to charge the EV 412. Based on the type of charging point required, the apparatus 10 may determine the suitable charging point for the EV 412. The apparatus 10 may automatically confirm the charge point is active, compatible, available, etc. In this example, an EV 414 may currently be utilizing the first charging point 410A, and an EV 416 may currently be utilizing the second charging point 410B, thus, the available charging point may be the third charging point 410C, and the fourth charging point 410D for any other EV (such as a fourth EV). Out of the available and compatible charging points at the charging station 406, the apparatus 10 may determine a charging point that may charge the EV 412 in the shortest time. In this example, the fifth charging point 410E may be determined as the charging point that can charge the EV 412 the fastest, as compared to the other available charging points, such as, the third charging point 410C and the fourth charging point 410D. Data required to determine an available charging point that can charge an EV in the minimum time may be obtained in real-time for the plurality of charge points 410 of the charging station 406, via an electronic device of an operator of the charging station 406. In some scenarios, this data may be determined based on the charging station metadata 266 associated with the charging station.

In this example, the EV 412 may have a low battery charge level, and it may take an estimated 1 hour for the battery of the EV 412 (also referred to as the first EV) to charge to 100%. Another EV, such as, the EV 414 (also referred to as the second EV), may presently be at 50% charge and may take an estimated 30 minutes to be completely charged based on a stated maximum power output of the first charging point 410A. When a newly arrived EV, such as, the EV 416 (also referred to as the third EV), plugs into the second charging point 410B, data such as the actual peak power available, etc., may be observed by the apparatus 10 in real time. This peak instantaneous power may differ from the stated maximum power output based on limitations around the local power grid, how dynamic power sharing is set to function by the charge point operator, etc. This real time data may be used by apparatus 10 as feedback to update one or more databases, route vehicles, etc. This data may also be utilized by the apparatus 10 to determine the availability of the charging points, and/or the queuing time and charging time of the charging station 406. Such real time data may be obtained from charging station operators or deduced by the apparatus 10 by monitoring charge speed, incoming power levels, etc. from internal systems of each EV of the plurality of EVs. This data may also be used to update the charging time estimation for each of EV utilizing the particular charging point of the plurality of charging points 410.

The apparatus 10 may also use a cost function/algorithm to consider the number of available charging points of the plurality of charging points 410 and their nominal maximum charging power, as well as the expected/derived charging power (known or estimated). This cost function may enable the apparatus 10 to prioritize or deprioritize recommendation depending on the user preferences (e.g., fastest charging available), queuing time, charging time, lowest cost, least strain on the power grid, etc.

It should also be noted in some examples that the apparatus 10, system, etc. may monitor availability of charging points (such as charging points from 410A-410E) of the charging station in addition to determining the queuing time and the charging time of the charging station 406.

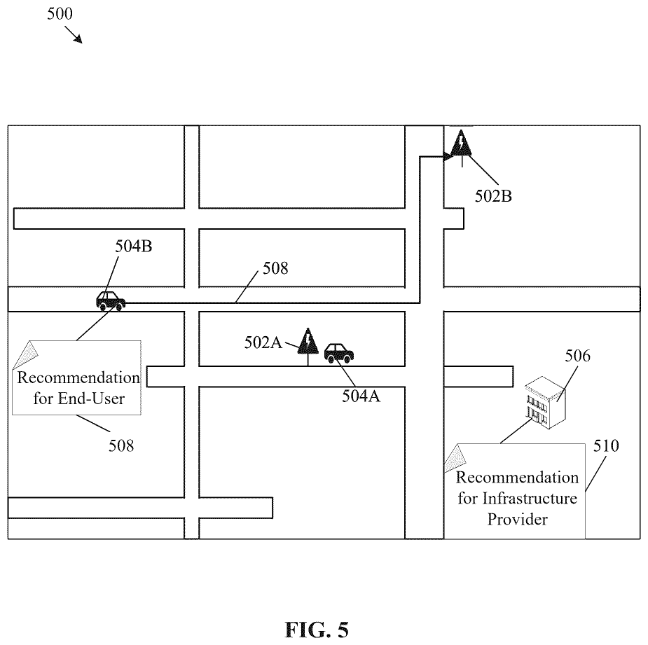

Turning to FIG. 5, a scenario diagram 500 of some of the examples discussed above is illustrated. The scenario diagram 500 is a graphical representation of an example scenario including a road segment, a plurality of charging stations (for example, a charging station 502A, and a charging station 502B), a plurality of EVs (for example, an EV 504A and an EV 504B), and a charging infrastructure provider 506. Specifically, in the scenario, the EV 504B may be shown to be driving towards the charging station 502A. Further, the scenario includes the EV 504A utilizing the charging station 502A. There is also shown, recommendation data 508 for the end-user associated with the EV 504B, and recommendation data 510 for the charging infrastructure provider 506, in the scenario.

In an example, the EV 504B, which having a battery level of 10%, may be navigated to the charging station 502A. The apparatus 10 may receive the location data of the EV 504B to determine a distance between the charging station 502A and the EV 504B. Further, the apparatus 10 may determine that the distance of the EV 504B from the charging station 502A is within or beyond the threshold proximate distance. Upon determining that the distance of the EV 504B is within the threshold proximate distance, the apparatus 10 may determine that there is a high likelihood the EV 504B will be charged at the charging station 502A based on this information. The apparatus 10 may determine (as described, for example, in FIG. 3A) the queuing time for the charging station 502A based on the end-user location data 252 and/or the EV location data 254, and the charging station metadata 266 of the charging station 502A. Further, the apparatus 10 may transmit (as described, for example, in FIG. 3B) the recommendation data 508 to an electronic device associated with the EV 504B. The recommendation data 508 may indicate the charging station 502B as a recommended charging station for charging of the EV 504B, based on the EV location data 254, and the queuing time 422 for the charging station 502A. Further, the apparatus 10 may transmit, in the recommendation data 508, a confirmation of the charge point of the charging station 502B that may be active, compatible, available, etc. for the EV 504B.

As shown in FIG. 5, as the charging station 502A may be in use by the EV 504A, the EV 504B may be navigated to the other charging station 502B, based on the recommendation data 508. In an example, a distance of the EV 504B from the charging station 502A may be lesser than a distance between the EV 504B and the charging station 502B. However, as the charging station 502A is in use and if the queuing time of the charging station 502A indicates that it is greater than a time required for the EV 504B to reach the farther charging station 502B, the recommendation data 508 may navigate the EV 504B to the charging station 502B instead of the charging station 502A.

Similar to the EV 504B, the apparatus 10 may transmit recommendation data (such as, the recommendation data 508) to another EV indicating the charging station as a recommended charging station, based at least on the charging station information, the queuing time and/or the charging time for the charging station.

Further in this example, the apparatus 10 may generate (as described, for example, in FIG. 3B) recommendation data 510 indicating a recommended charging capacity the charging station 502A (or any other charging station such as the charging station 502B), based at least on the charging station information (see block 30, refer FIG. 3A) and the queuing time and/or the charging time for the charging station 502A and transmit the recommendation data 510 to an electronic device associated with the charging infrastructure provider 506.

In this example, the apparatus 10 may receive charging station information of the plurality of charging stations. The charging station information may include the charging station location data 250 and the charging station metadata 266. Further, the apparatus 10 may determine the queuing statistics 260 for the plurality of charging stations (including, for example, the charging station 502A or the charging station 502B), based on the queuing time for the charging station 502A and queuing times for other charging stations of the plurality of charging stations. The queuing statistics may include queuing times associated with the plurality of charging stations, based on various factors, such as, but not limited to, location-specific queuing time, charger-specific queuing time, charging capacity-specific queuing time, time-of-day-specific queuing time, or month-specific queuing time factors. Thus, the queuing time for the charging station may be determined based on estimation of the time using various factors, associated with the plurality of charging stations. The queuing statistics 260 may be further based on the climate data 258.

For example, the current charging capacity of the charging station 502A may be 100 KW-1000 KW, and the queuing time may be 40 minutes on a rainy day and the queuing time may be 5 minutes on a sunny day (based on, for example, the time-of-day-specific factor, such as, in the morning between 10-11 AM). Further, the apparatus 10 may generate and transmit the recommendation data 510 to the electronic device of the charging infrastructure provider 506. The recommendation data 510 may indicate recommended charging capacity to be installed 612 as 100 KW-3000 KW.

The apparatus 10 may extract the current charging capacity of the plurality of charging stations from the charging station information (received at block 30, refer FIG. 3A). Further, the apparatus 10 may generate the recommendation data 510 indicating a recommended charging capacity at the plurality of charging stations, based on the current charging capacity, and the queuing time for the plurality of charging stations.

In this example, the apparatus 10 may determine charging statistics (such as, the charging statistics 264) for the plurality of charging stations, based on the charging time for the charging station 502A and charging times for other charging stations of the plurality of charging stations. The charging statistics may include charging times associated with the plurality of charging stations, based on various factors, such as, but not limited to, the location-specific charging time, the charger-specific charging time, the charging capacity-specific charging time, the time-of-day-specific charging time, or the month-specific charging time factors. Thus, the charging time for the charging station may be determined based on estimation of the time using various factors, associated with the plurality of charging stations. The charging statistics 264 may be further based on the climate data 258.

The apparatus 10 may extract the current charging capacity of the plurality of charging stations from the charging station information (received at block 30, refer FIG. 3A). Further, the apparatus 10 may generate the recommendation data 510 indicating a recommended charging capacity at the plurality of charging stations, based on the current charging capacity, and the charging time for the plurality of charging stations.

In an alternative example, the current charging capacity of the charging station 502A may be 100 KW-1000 KW, and the charging time may be 20 minutes on a rainy day and the charging time may be 5 minutes on a sunny day (based on, for example, the month-specific factor, such as, in the month of June). Further, the apparatus 10 may generate and transmit the recommendation data 510 to the electronic device of the charging infrastructure provider 506. The recommendation data 510 may indicate the recommended charging capacity as 100 KW-3000 KW.

Further, the electronic device of the charging infrastructure provider 506 may be equipped with a user interface (UI) (such as, the user interface 18) that may receive the transmitted recommendation data 510 from the apparatus 10. This recommendation data may be received via an end user device graphical user interface (GUI) running upon a smartphone, tablet, integrated vehicle navigation system, etc. Upon receiving the recommendation data, the electronic device of the charging infrastructure provider 506 may display the recommendation data to a user of the charging infrastructure provider 506 and guide the user to install the recommended charging capacity at the plurality of charging stations.

Turning to FIG. 6, a scenario diagram 600 of some of the examples discussed above is illustrated. The scenario diagram 600 is a graphical representation of an example scenario including a road segment, a plurality of charging stations (for example, a charging station 502A and a charging station 502B), a plurality of EVs (for example, an EV 602A and an EV 602A), and a charging station search-provider or a charging station routing-provider 604. Specifically, in the scenario, the EV 602B may be shown to be driving towards the charging station 502A. Further, the scenario includes the EV 602A utilizing the charging station 502A. There is also shown, recommendation data 604A (including recommended routes) for the end-user associated with the charging station routing-provider 604, in the scenario. Also, recommendation data for end-users associated with the plurality of EVs may also be provided.

In this example, the apparatus 10 may generate (as described, for example, in FIG. 3B) the recommendation data 604A indicating the charging station 502B (or any other charging station) as a recommended charging station, based at least on the charging station information (see block 30), and the queuing time and/or the charging time for charging stations and transmit the recommendation data 604A to an electronic device associated with the charging station search-provider or the charging station routing-provider 604. Further, the charging station routing-provider 604 may determine a plurality of routing options for the EV 602B to navigate to the recommended charging station.

In this example, the EV 602B, which may have a battery level of 50%, may be navigated to the charging station 502B. The apparatus 10 may receive the EV location data 254 to determine a distance between the charging station 502A or 502B and the EV 602B. Further, upon determining that the distance of the EV 602B from the charging station 502B is beyond the threshold proximate distance, the apparatus 10 may determine that there is a high likelihood that the EV 602B may need charging. Thus, the apparatus 10 may determine the queuing time and the charging time for the charging station 502B and other charging stations from the plurality of charging station to generate the recommendation data indicating one or more charging stations as recommended charging stations for charging of the EV 602B, based at least on the EV location data 254, the charging station location data 250, the queuing time, the charging time for the charging station (and/or any other charging station available). The apparatus 10 may transmit the recommendation data to an electronic device of the EV 602B. Further, the apparatus 10 transmit, in the recommendation data, a confirmation of the charge point of the charging station 502B (and/or any other charging station apart from the charging station 502A) that may be active, compatible, available, etc. for the EV 602B.

In this example, the apparatus 10 may generate the recommendation data 604A indicating the charging station 502B (or any other charging station) as a recommended charging station, based at least on the charging station information (see block 30) and the queuing time or the charging time for the charging station 502B and transmit the recommendation data 604A to an electronic device associated with the charging station search-provider or the charging station routing-provider 604.

In this example, the apparatus 10 may determine the queuing statistics 260 or the charging statistics 264 for a plurality of charging stations (including, for example, the charging station 502A or 502B), based on the queuing time or the charging time for the charging station and the queuing times or the charging times for other charging stations of the plurality of charging stations. The apparatus 10 may extract the charging station location data 250 of the plurality of charging stations from the charging station information (received at block 30). Further, the apparatus 10 may generate and transmit the recommendation data 604A indicating the charging station as a recommended charging station, based on the location of the charging station of the plurality of charging station, and the queuing time or charging time for the plurality of charging stations. The recommendation data 604A may further include a plurality of routing options, a plurality of distances, and times associated with each routing options based on charging station information, and a route recommended (by the apparatus 10) for the end-user associated with the EV 602B.

Further, the electronic device of charging station search-provider or the charging station routing-provider 604 may be equipped with a user interface (UI) (such as, the user interface 18) that may receive the recommendation data 604A from the apparatus 10. This recommendation data may be received via an end user device graphical user interface (GUI) running upon a smartphone, tablet, integrated vehicle navigation system, etc. Upon receiving the recommendation data 604A, the electronic device of the charging station routing-provider 604 may display the recommendation data 604A to the end-user of the charging station routing-provider 604 and guided the end-user to navigate to the recommended charging station of the plurality of charging station.

For example, the apparatus 10 may determine the plurality of routing options for the EV 602B to reach the charging station 502B (of the plurality of charging stations) along with the distances and the times (from the charging station based on charging station information). The plurality of routing options include a “Route 1” 608A with a distance of 10 km and time 20 min, a “Route 2” 608B with a distance of 4 km and time 15 min, or a “Route 3” 608C with a distance of 5 km and time 40 min. Thus, the apparatus 10 may generate and transmit the recommendation data 604A indicating route recommended to the end user, based on the routing options to the electronic device of the charging station search-provider or the charging station routing-provider 604. In an example, the route recommended to the end-user may be the “Route 2” 608B as this route may be require the EV 602B to travel a minimum distance within a minimum time to reach the recommended charging station 502B of the plurality of charging stations. Further, the GUI of the electronic device of charging station search-provider or the charging station routing-provider 604 may display the route recommended to the end-user.

The apparatus 10 may generate an automated vehicle control signal based at least in part on the queuing time or the charging time of the charging station (such as, the charging station 502A or charging station 502B). The automated vehicle control signal may be an electronic signal that may be generated by an automated vehicle control system to manage, navigate, direct operations associated with the EV (such as the EV 602A or the EV 602B). These signals may be a part of the communication between the plurality of EVs (such as the EVs 602A or 602B), the plurality of charging stations (such as the charging station 502A or 502B), the charging infrastructure provider 506, and the charging station routing-provider 604. Further, the automated vehicle control signal may also be a part of communication between various sensors, control units, and actuators within an EV to ensure the EV performs desired actions accurately and safely. For example, the automated vehicle control signal may include a steering control signal, an acceleration and breaking signal, a collision avoidance signal, a parking assistance signal, a sensor data signals, a communication signal, etc. Thus, the automated vehicle control signal may enable the EV to perceive an environment associated with the EV, make decisions, and execute actions to ensure safe and efficient operation. Further, the automated vehicle control signal may enable the apparatus 10 to control the operation of the plurality of EVs with minimal or no human intervention.

In an example, the automated vehicle control signal may be associated with an automated vehicle control that may include an adaptive cruise control (ACC), a lane keeping assistance (LKA), an automatic braking system (ABS), parking assistance, a traffic jam assistance, autonomous driving, etc.

It will be understood that each node block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 14 of an apparatus 10 employing an embodiment of the present invention and executed by the processing circuit 12. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Furthermore, in some embodiments, additional optional operations may be included. Modifications, additions, or amplifications to the operations above may be performed in any order and in any combination.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method, comprising:
receiving charging station information including charging station location data and charging station metadata of a charging station;
receiving first location data of an electric vehicle (EV) based on a distance of the EV from the charging station being within a threshold proximate distance;
receiving second location data of the EV based on a determination that the EV is utilizing a charging point of the charging station; and
determining a queuing time for the charging station, based at least in part on the first location data, the second location data, and the charging station metadata.

2. The method according to claim 1, wherein the charging station location data, first location data, or the second location data is determined based on at least one of Global Positioning System (GPS) data, Global Navigation Satellite System (GNSS) data associated, or vehicle sensor data.

3. The method according to claim 1, wherein the first location data or the second location data at least includes:
a current geographical location of the EV, and
a current timestamp at the current geographical location.

4. The method according to claim 1, wherein the charging station metadata includes at least one of:
a number of operational charging points at the charging station,
a charger power output associated with each of the operational charging points,
an availability of a fast-charging point among the charging points, or
a charging time required for one or more EV models.

5. The method according to claim 1, further comprising:
receiving location data of a second EV;
generating recommendation data indicating the charging station as a recommended charging station for charging of the second EV, based at least on the location data of the second EV, the charging station location data, and the queuing time for the charging station; and
transmitting the recommendation data to an electronic device associated with the second EV.

6. The method according to claim 1, further comprising:
generating recommendation data indicating a recommended charging capacity at the charging station, based at least on the charging station information and the queuing time for the charging station; and
transmitting the recommendation data to an electronic device associated with a charging infrastructure provider.

7. The method according to claim 1, further comprising:
generating recommendation data indicating the charging station as a recommended charging station, based at least on the charging station information and the queuing time for the charging station; and
transmitting the recommendation data to an electronic device associated with a charging station search-provider or a charging station routing-provider.

8. The method according to claim 1, further comprising:
determining queuing statistics for a plurality of charging stations including the charging station, based on the queuing time for the charging station and queuing times for other charging stations of the plurality of charging stations, wherein the queuing statistics includes at least one of:
location-specific queuing times associated with the plurality of charging stations,
charger-specific queuing times associated with the plurality of charging stations,
charging capacity-specific queuing times associated with the plurality of charging stations,
time-of-day-specific queuing times associated with the plurality of charging stations, or
month-specific queuing times associated with the plurality of charging stations.

9. The method according to claim 1, further comprising receiving climate data associated the charging station location data, wherein the determination of the queuing time is further based on the climate data.

10. The method according to claim 1, further comprising generating an automated vehicle control signal based at least in part on the queuing time of the charging station.

11. An apparatus, the apparatus comprising at least one processor and at least one memory storing computer program code, the at least one memory and the computer program code configured to, with the processor, cause the apparatus to at least:
receive charging station information including charging station location data and charging station metadata of a charging station;
receive first location data of an electric vehicle (EV) based on a distance of the EV from the charging station being within a threshold proximate distance;
receive second location data of the EV based on a determination that the EV is utilizing a charging point of the charging station; and
determine a queuing time for the charging station, based at least in part on the first location data, the second location data, and the charging station metadata.

12. The apparatus of claim 11, wherein the charging station location data, the first location data, or the second location data is determined based on at least one of Global Positioning System (GPS) data, Global Navigation Satellite System (GNSS) data associated, or vehicle sensor data.

13. The apparatus of claim 11, wherein the first location data of the EV or the second location data of the EV at least includes:
a current geographical location of the EV, and
a current timestamp at the current geographical location.

14. The apparatus of claim 11, wherein the charging station metadata includes at least one of:
a number of operational charging points at the charging station,
a charger power output associated with each of the operational charging points,
an availability of a fast-charging point among the charging points, or
a charging time required for one or more EV models.

15. The apparatus of claim 11, the at least one memory and the computer program code are further configured to, with the processor, cause the apparatus to at least:
receive location data of a second EV;
generate recommendation data indicating the charging station as a recommended charging station for charging of the second EV, based at least on the location data of the second EV, the charging station location data, and the queuing time for the charging station; and
transmit the recommendation data to an electronic device associated with the second EV.

16. The apparatus of claim 11, the at least one memory and the computer program code are further configured to, with the processor, cause the apparatus to at least:
generate recommendation data indicating a recommended charging capacity at the charging station, based at least on the charging station information and the queuing time for the charging station; and
transmit the recommendation data to an electronic device associated with a charging infrastructure provider.

17. The apparatus of claim 11, the at least one memory and the computer program code are further configured to, with the processor, cause the apparatus to at least:
generate recommendation data indicating the charging station as a recommended charging station, based at least on the charging station information and the queuing time for the charging station; and
transmit the recommendation data to an electronic device associated with a charging station search-provider or a charging station routing-provider.

18. The apparatus of claim 11, the at least one memory and the computer program code are further configured to, with the processor, cause the apparatus to at least:
determine queuing statistics for a plurality of charging stations including the charging station, based on the queuing time for the charging station and queuing times for other charging stations of the plurality of charging stations, wherein the queuing statistics includes at least one of:
location-specific queuing times associated with the plurality of charging stations,
charger-specific queuing times associated with the plurality of charging stations,
charging capacity-specific queuing times associated with the plurality of charging stations,
time-of-day-specific queuing times associated with the plurality of charging stations, or
month-specific queuing times associated with the plurality of charging stations.

19. The apparatus of claim 11, the at least one memory and the computer program code are further configured to, with the processor, cause the apparatus to at least receive climate data associated the charging station location data, wherein the determination of the queuing time is further based on the climate data.

20. The apparatus of claim 11, the at least one memory and the computer program code are further configured to, with the processor, cause the apparatus to at least generate an automated vehicle control signal based at least in part on the queuing time of the charging station.
